(19) United States
(12) Patent Application Publication
(10) Pub. No.: US 2021/0300013 A1
(43) Pub. Date: Sep. 30, 2021

(54) SQUEEGEE, PRINTING EQUIPMENT, AND PRINTING METHOD OF SUBSTRATE

(71) Applicant: Shenzhen China Star Optoelectronics Semiconductor Display Technology Co., Ltd., Shenzhen, Guangdong (CN)

(72) Inventors: Xin ZHANG, Shenzhen, Guangdong (CN); Juncheng XIAO, Shenzhen, Guangdong (CN); Jia LI, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/969,192

(22) PCT Filed: May 21, 2020
(86) PCT No.: PCT/CN2020/091596

§ 371 Date: Aug. 12, 2020

(30) Foreign Application Priority Data
Mar. 26, 2020 (CN) 202010225268.0

(51) Int. Cl. B41F 15/02; B41F 15/44

(52) U.S. Cl. CPC B41F 15/02; B41F 15/44

(57) ABSTRACT

The present application disclosed a squeegee, a printing equipment, and a printing method of substrate. The squeegee comprises a handle and a blade. The handle is used for connecting the squeegee with a printing frame. A protective layer is disposed on one side of the blade away from the handle. Compared with prior art, by disposing the protective layer on one side of the blade away from the handle, the embodiments of the present application effectively enhance the cushioning effect of the squeegee, thereby preventing screen printing from indirect damage of the squeegee to the substrate, and thereby improving process yields.

### FIELD OF INVENTION

The application relates to printing technology, and especially relates to a squeegee, a printing equipment, and a printing method of substrate.

### BACKGROUND OF INVENTION

At present, screen printing is called universal printing. Screen printing can be performed on various substrates, such as various plastics, textiles, metals, glasses, printed circuit boards, etc. Therefore, screen printing is widely used in advertising, art, architecture, publishing, dying and industrial fields, such as electronics. Especially in the electronics industry, the share of screen printing technology is as high as 90%, which shows the importance of screen printing.

A conventional screen printer includes a framework, an alignment component, a printing component and a conveying component. The alignment component is disposed on one side of the framework. The printing component is disposed on the other side of the framework. The substrate is placed on the alignment component to be aligned in advance. The conveying component conveys the substrate from the alignment component into the printing component for printing.

The printing component comprises a printing platform and a printing rack. The printing platform is disposed on the framework. The printing rack is disposed above the printing platform. The printing rack is provided with a screen installation part used for installing the screen and for covering the substrate with the screen. The printing rack is provided with a squeegee part used for squeegeeing the printing ink on the screen onto the substrate.

### TECHNICAL PROBLEM

However, when the squeegee part is being pressed against the screen, the pressing force between the squeegee part and the screen cannot be adjusted. The component in contact with the squeegee part can be easily damaged during the long process of pressing and sliding of the squeegee part onto the screen if the pressing force between the squeegee part and the screen is too strong. This is especially true when a thin film transistor (TFT) process is performed on a glass substrate. Micro light emitting diodes (micro LEDs) driven by TFT is a new technical field. Because the glass substrate is softer and more fragile compared with the printed circuit board, the glass substrate is easily deformed in a surface mounting process, thereby causing mounting sites to deviate or to crack.

### SUMMARY OF INVENTION

### Technical Solution

The embodiments of the present application provide a squeegee, a printing equipment, and a printing method of substrate. By disposing a protective layer on one side of a blade away from a handle, the embodiments of the present application effectively enhance the cushioning effect of the squeegee, thereby preventing screen printing from indirect damage of the squeegee to the substrate, and thereby improving process yields.

In a first aspect, embodiments of the present application provide a squeegee, comprises: a handle and a blade;

wherein the handle is used for connecting the squeegee with a printing frame; and a protective layer is disposed on one side of the blade away from the handle.

In some embodiments, the protective layer comprises at least one of a plastic film, a rubber layer, and a silicone layer.

In some embodiments, the plastic film is made of polytetrafluoroethylene, perfluoroalkoxy alkane, polyvinyl chloride, ultra-high molecular weight polyethylene or polypropylene.

In some embodiments, the thickness of the blade is in a range of between 0.05 mm and 2 mm.

In some embodiments, the thickness of the protective layer is in a range of between 0.001 mm and 1 mm.

In some embodiments, the protective layer covers one side of the blade away from the handle.

In some embodiments, the protective layer is glued on the blade.

In a second aspect, embodiments of the present application provide a printing equipment, comprises: a squeegee part and a printing frame;

wherein the squeegee part is disposed on the printing frame and comprises at least one squeegee; the squeegee comprises a handle and a blade; the handle is used for connecting the squeegee with the printing frame; and a protective layer is disposed on one side of the blade away from the handle.

In some embodiments, the protective layer comprises at least one of a plastic film, a rubber layer, and a silicone layer.

In some embodiments, the plastic film is made of polytetrafluoroethylene, perfluoroalkoxy alkane, polyvinyl chloride, ultra-high molecular weight polyethylene or polypropylene.

In some embodiments, the thickness of the blade is in a range of between 0.05 mm and 2 mm.

In some embodiments, the thickness of the protective layer is in a range of between 0.001 mm and 1 mm.

In some embodiments, the protective layer covers one side of the blade away from the handle.

In some embodiments, the protective layer is glued on the blade.

In a third aspect, embodiments of the present application provide a printing method of substrate, comprises steps of:

preparing a printing equipment, wherein the printing equipment is as described in the second aspect;

preparing a printing substrate; and

printing the printing substrate by using the printing equipment.

In some embodiments, printing the printing substrate by using the printing equipment comprises steps of:

laying a steel mesh on the printing substrate; and

using the squeegee to print the printing substrate laid with the mesh.

Beneficial Effect:

The squeegee provided by the embodiments of the present application comprises the handle and the blade. The handle is used for connecting the squeegee with the printing frame. The protective layer is disposed on one side of the blade away from the handle. Compared with the prior art, by disposing the protective layer on one side of the blade away from the handle, the embodiments of the present application effectively enhance the cushioning effect of the squeegee, thereby preventing screen printing from indirect damage of the squeegee to the substrate, and thereby improving process yields.

### DESCRIPTION OF DRAWINGS

By describing the embodiments of the present application in detail in conjunction with the drawings, the technical solution of the present application and the beneficial effect of the technical solution is made apparent to those skilled in the art. In the drawings:

FIG. 1 is a structural schematic view of a squeegee provided by the embodiments of the present application.

FIG. 2 is a schematic flowchart of printing method of substrate provided by the embodiments of the present application.

### DETAILED DESCRIPTION OF PREFERRED EMBODIMENTS

The technical solutions in the embodiments of the present disclosure are clearly and completely described as follows with reference to the accompanying drawings in the embodiments. It is apparent that the described embodiments are only a part of the embodiments of the present disclosure, and not all of the embodiments. All other embodiments obtained by a person skilled in the art based on the embodiments of the present disclosure without inventive efforts are within the scope of the present disclosure.

In the description of the present disclosure, it is to be understood that the oriental and the positional relationships of the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are based upon the oriental or positional relationship shown in the drawings, are merely for facilitating and simplifying the description of the present disclosure, and do not indicate or imply that the device or components referred to have a specific orientation, and are constructed and operated in a specific orientation. Therefore, it should not be construed as limiting the disclosure. Moreover, the terms “first” and “second” are used for descriptive purposes only and are not to be construed as indicating or implying a relative importance or implicitly indicating the number of indicated technical features. Thus, features defining “first” or “second” may include one or more of the described features either explicitly or implicitly. In the description of the present disclosure, the meaning of “a plurality of” is two or more unless specifically defined otherwise.

In the present disclosure, it is noted that, unless otherwise explicitly set forth and defined, the terms “mount”, “contact”, and “connect” should be understood broadly, and, for example, may be fixedly connected, detachably connected, integrally connected, mechanically connected, electrically connected, directly connected, or indirectly connected through an intermediate medium, or internally communicated within two components. For those of ordinary skill in the art, the specific meaning of these terms in the present disclosure should be understood on a basis of a specific case situation.

In the present disclosure, unless otherwise expressly stated and defined, the description that “a first feature is on or under a second feature” may mean that the first feature directly contacts the second feature, or mean that the first feature contacts the second feature via another feature therebetween, rather than directly contact the second feature. Moreover, the description that “the first feature is on/above/over the second feature” may mean that the first feature is directly or obliquely on/above/over the second feature, or just mean the horizontal height of the first feature is higher than that of the second feature. The description that “the first feature is under/below/beneath the second feature” may mean that the first feature is directly or obliquely under/below/beneath the second feature, or just mean the horizontal height of the first feature is lower than that of the second feature.

The following description provides a number of different embodiments or examples for implementing the different structures of the present disclosure. In order to simplify the present disclosure, components and arrangements of specific examples are described below. Certainly, the examples are merely exemplary and are not intended to limit the present disclosure. In addition, for the sake of simplicity and clarity, the reference numerals and/or the reference letters may repeat in different examples in the present disclosure, which does not indicate the relationship between the various discussed embodiments and/or arrangements. Moreover, the examples of various specific processes and materials are provided in the present disclosure, but a person of ordinary skill in the art will appreciate the application of other processes and/or the use of other materials.

The embodiments of the present application provide a squeegee, a printing equipment, and a printing method of substrate. The detailed description is given hereinbelow.

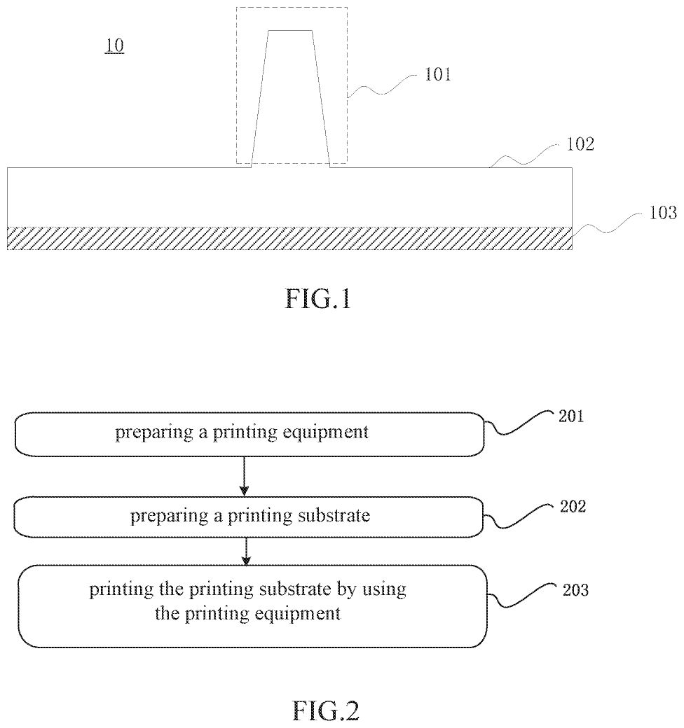

Refer to FIG. 1. FIG. 1 is a structural schematic view of a squeegee provided by the embodiments of the present application. The squeegee 10 comprises a handle 101 and a blade 102. The handle 101 is used for connecting the squeegee 10 with a printing frame. A protective layer 103 is disposed on one side of the blade 102 away from the handle 101.

In the present application, the squeegee 10 comprises the handle 101 and the blade 102. There may be one or two handles. Squeegee 10 with two handles 101 may be chosen when large printing plates are printed, so the squeegee 10 can withstand strong force. Specific structure depends on the actual need and is not limited herein.

In summary, by disposing the protective layer 103 on one side of the blade 102 away from the handle 101, the embodiments of the present application effectively enhance the cushioning effect of the squeegee 10, thereby preventing screen printing from indirect damage of the squeegee to the substrate, and thereby improving process yields.

In some embodiments, in order to ensure the protective performance of the protective layer 103, for the selection of the material of the protective layer 103, the protective layer may be made of at least one of a plastic film, a rubber layer, and a silicone layer.

Specifically, the protective layer 103 may be made of a plastic film, a rubber layer, a silicone layer, or any other material that can act as a cushioning and protective material. The specific material is not limited herein.

In some embodiments, the plastic film may be made of polytetrafluoroethylene, perfluoroalkoxy alkane, polyvinyl chloride, ultra-high molecular weight polyethylene or polypropylene

In some embodiments, the thickness of the blade 102 is in a range of between 0.05 mm and 2 mm, such as 1 mm to ensure maximum squeegeeing effect during the use of the squeegee 10.

In some embodiments, the thickness of the protective layer 103 may range from 0.001 mm to 1 mm such as 0.50 mm to ensure that the protective layer 103 plays the role of protection without affecting the squeegeeing effect.

In some embodiments, the protective layer 103 covers one side of the blade 102 away from the handle 101.

Specifically, the protective layer 103 is disposed on one side of the blade 102 away from the handle 101, wherein the protective layer103 may be glued on the blade 102. Alternatively, the protective layer 103 may be adhered to the blade 102 by the cooling and solidifying of the protective layer 103 itself. Limitations are not made herein.

To preferably implementing the squeegee 10 of the present application, the embodiments of the present application also provide a printing equipment. The printing equipment comprises a squeegee part and a printing frame. The squeegee part is disposed on the printing frame and comprises at least one squeegee as described in the aforementioned embodiments.

In the present embodiment, the squeegee part comprises at least one squeegee 10. Specifically, the squeegee part may be provided with one or more squeegee 10. For example, two squeegees 10 may be disposed on the squeegee part. The two squeegees are disposed parallel to each other. In the specific implementation, the two squeegees 10 may be disposed at the same height and at different angles. Specific settings may depend on the actual need and is not limited herein.

The printing equipment of the present application may be applied in the field of electronics industry. The substrate is circuit board. The printing equipment of the present application may print signs of the electronic devices onto the circuit board.

In some embodiments, the squeegee part may comprises a squeegee sliding base, a squeegee beam, and a squeegee component. The squeegee sliding base is slidingly mounted on both sides of the printing rack and can slide along the printing rack. The squeegee beam is disposed on the squeegee sliding base and is placed laterally above the printing platform. The squeegee component is disposed on the squeegee beam. Wherein synchronous pulleys are disposed on the front end and on the rear end of the printing rack. A synchronous belt is connected to the synchronous pulleys. A squeegee electric motor used for driving the synchronous pulleys to rotate is disposed on the printing rack. Thus, the squeegee part is moved along the printing rack under the control of the squeegee electric motor.

The squeegee component comprises two squeegee mounting bases. The squeegee mounting base is slidingly mounted on the squeegee beam and can be fixed on the squeegee beam. The squeegee mounting base is provided with a squeegee supporting rack. A squeegee supporting plate is vertical slidingly mounted on the squeegee supporting rack. The squeegee 10 is disposed on the squeegee supporting plate. The squeegee supporting rack is provided with a squeegee driving cylinder s used for driving the squeegee supporting plate to slide, thereby pressing the squeegee 10 to the screen.

It should be noted that in the aforementioned printing equipment embodiment, only aforementioned structures are described. It can be understood that any other necessary structures, such as a control motor, an alignment clamping piece, an adjustment part, and an alignment platform may also be included in the printing equipment of the embodiments of the present application according to the need. The structures are not specifically limited herein.

In summary by using the squeegee 10 of the aforementioned embodiment and by disposing the protective layer 103 on one side of the blade 102 away from the handle 101, the embodiments of the present application effectively enhance the cushioning effect of the squeegee 10, thereby preventing screen printing from indirect damage of the squeegee to the substrate, and thereby improving process yields.

A printing method of substrate is also provided in order to preferably apply the printing equipment of the present application. The printing method comprises: preparing a printing equipment, wherein the printing equipment is the printing equipment in the aforementioned embodiments; preparing a printing substrate; and printing the printing substrate by using the printing equipment.

Refer to FIG. 2. FIG. 2 is a schematic flowchart of printing method of substrate provided by the embodiments of the present application, wherein the method comprises:

Step 201 of preparing a printing equipment, wherein the printing equipment is the printing equipment in the above embodiment.

Step 202 of preparing a printing substrate.

Step 203 of printing the printing substrate by using the printing equipment.

Specifically, the embodiments of the present application generally use screen printing. The equipment of screen printing generally comprises a screen plate, a printing squeegee, ink, a printing station, and substrate. Screen printing is based on the basic principle that the graphic part of the screen plate is penetrable to the ink, and the non-graphic part of the screen plate is not penetrable to the ink.

During printing, the ink is poured from one end of the screen plate, a certain pressure is applied onto the ink part of the screen plate with the printing squeegee, and the printing squeegee is moved towards the other end of the printing screen at the same time. The ink is squeezed by the squeegee from screen meshes of the graphic part to the substrate while the squeegee is moving.

The print is fixed within a certain range due to the viscosity of the ink. The squeegee maintains in linear contact with the screen plate and the substrate throughout the printing process. The line of contact moves along with the squeegee. Because a certain size gap is maintained between the screen plate and the substrate, a reaction force is generated by the tension of the screen plate. The reaction force is called the resilience. Due to the resilience, the screen plate and the substrate are only in movable linear contact, while other parts of the screen plate are in separation from the substrate. Thus, a movement of fracture occurs between the ink and the screen, thereby ensuring the dimensional precision of the printing, and thereby avoiding smearing the substrate. A printing stroke is completed when the squeegee is raised after going through the whole screen, the screen plate is also raised, and the ink is squeegeed back to the initial position.

In some embodiments, printing the printing substrate by using the printing equipment comprises steps of:

laying a steel mesh on the printing substrate; and using the squeegee 10 to print the printing substrate laid with the mesh.

In the aforementioned embodiments, the description of each embodiment has its own emphasis. For a part that is not detailed in an embodiment, refer to related descriptions in other embodiments.

The squeegee 10, printing equipment, and printing method of substrate provided by the embodiments of the present application are described in detail hereinabove. Specific examples are used herein to explain the principles and implementations of the present disclosure. The descriptions of the above embodiments are only used to help understand the technical solutions and core ideas of the present disclosure. Those of ordinary skill in the art should understand that t the technical solutions described in the foregoing embodiments can still be modified, or some of the technical features can be equivalently replaced. These modification and replacement do not deviate the essence of the corresponding technical solutions from the scope of the technical solutions of the embodiments of the present disclosure.

What is claimed is:

1. A squeegee, comprising: a handle and a blade;
wherein the handle is used for connecting the squeegee with a printing frame; and
a protective layer is disposed on one side of the blade away from the handle.

2. The squeegee as claimed in claim 1, wherein the protective layer comprises at least one of a plastic film, a rubber layer, and a silicone layer.

3. The squeegee as claimed in claim 2, wherein the plastic film is made of polytetrafluoroethylene, perfluoroalkoxy alkane, polyvinyl chloride, ultra-high molecular weight polyethylene or polypropylene.

4. The squeegee as claimed in claim 1, wherein the thickness of the blade is in a range of between 0.05 mm and 2 mm.

5. The squeegee as claimed in claim 1, wherein the thickness of the protective layer is in a range of between 0.001 mm and 1 mm.

6. The squeegee as claimed in claim 1, wherein the protective layer covers one side of the blade away from the handle.

7. The squeegee as claimed in claim 1, wherein the protective layer is glued on the blade.

8. A printing equipment, comprising: a squeegee part and a printing frame;
wherein the squeegee part is disposed on the printing frame and comprises at least one squeegee; the squeegee comprises a handle and a blade; the handle is used for connecting the squeegee with the printing frame; and a protective layer is disposed on one side of the blade away from the handle.

9. The squeegee as claimed in claim 8, wherein the protective layer comprises at least one of a plastic film, a rubber layer, and a silicone layer.

10. The squeegee as claimed in claim 9, wherein the plastic film is made of polytetrafluoroethylene, perfluoroalkoxy alkane, polyvinyl chloride, ultra-high molecular weight polyethylene, or polypropylene.

11. The squeegee as claimed in claim 8, wherein the thickness of the blade is in a range of between 0.05 mm and 2 mm.

12. The squeegee as claimed in claim 8, wherein the thickness of the protective layer is in a range of between 0.001 mm and 1 mm.

13. The squeegee as claimed in claim 8, wherein the protective layer covers one side of the blade away from the handle.

14. The squeegee as claimed in claim 8, wherein the protective layer is glued on the blade.

15. A printing method of substrate, comprising steps of:
preparing a printing equipment, wherein the printing equipment is as claimed in claim 8;
preparing a printing substrate; and
printing the printing substrate by using the printing equipment.

16. The printing method as claimed in claim 15, wherein printing the printing substrate by using the printing equipment comprises steps of:
laying a steel mesh on the printing substrate; and
using the squeegee to print the printing substrate laid with the mesh.
